(19) United States
(12) Patent Application Publication
(10) Pub. No.: US 2015/0246481 A1
(43) Pub. Date: Sep. 3, 2015

(54) CREATION OF RESIDUAL COMPRESSIVE STRESSES DURING ADDITVE MANUFACTURING

(71) Applicant: MTU Aero Engines AG, Muenchen (DE)

(72) Inventors: Georg Schlick, Muenchen (DE); Herbert Hanrieder, Hohenkammer (DE); Andreas Jakimov, Muenchen (DE); Thomas Goehler, Dachau (DE)

(21) Appl. No.: 14/633,917

(22) Filed: Feb. 27, 2015

(30) Foreign Application Priority Data
Feb. 28, 2014 (DE) DE102014203711.5

(51) Int. Cl. B29C 67/00; B29C 35/00

(52) U.S. Cl. CPC B29C 67/0051; B29C 35/00; B33Y 10/00

(57) ABSTRACT

An apparatus and method for additive manufacturing of components, in particular for manufacturing components for turbomachines, where the component is at least partially built up layer by layer on a substrate or a previously produced part of the component, and where layer-by-layer build-up is performed by layerwise melting of powder material using a high-energy beam and solidification of the molten powder is provided. The high-energy beam moves along a path across the powder material and produces a melting region at the front of the path. A solidification region forms subsequently in the path. In the solidification region, the temperature distribution is temporally and/or locally selected in such a way that residual compressive stresses are produced in the solidified or solidifying powder material.

This claims the benefit of German Patent Application DE 10 2014 203 711.5, filed Feb. 28, 2014 and hereby incorporated by reference herein.

The present invention relates to a method for additive manufacturing of components, in particular for manufacturing components for turbomachines, in which method the component is built up layer by layer on a substrate or a previously produced part of the component, and in which layer-by-layer build-up is performed by layerwise melting of powder material using a high-energy beam and solidification of the melt.

### BACKGROUND

Additive manufacturing methods for producing a component, such as, for example, selective laser melting, electron beam melting or laser deposition welding, are used in industry for what is known as rapid tooling, rapid prototyping and also for rapid manufacturing of repetition components. In particular, such methods may also be used for manufacturing turbine components, particularly components for aircraft engines, where such additive manufacturing methods are advantageous, for example, because of the material used. An example of this is found in DE 10 2010 050 531 A1.

In this method, such a component is manufactured by layer-by-layer deposition of at least one component material in powder form onto a component platform in a region of a buildup and joining zone and local layer-by-layer melting of the component material by energy supplied in the region of the buildup and joining zone. The energy is supplied via laser beams of, for example, CO₂ lasers, Nd:YAG lasers, Yb fiber lasers, as well as diode lasers, or by electron beams. In the method described in DE 10 2009 051 479 A1, moreover, the component being produced and/or the buildup and joining zone are heated to a temperature slightly below the melting point of the component material using a zone furnace in order to maintain a directionally solidified or monocrystalline crystal structure.

German Patent Application DE 10 2006 058 949 A1 also describes a device and a method for the rapid manufacture and repair of the tips of blades of a gas turbine, in particular of an aircraft engine, where inductive heating is employed together with laser or electron-beam sintering.

Inductive heating of the component to be manufactured is also described in EP 2 359 964 A1 in connection with the additive manufacture of a component by selective laser sintering.

International Patent Application WO 2008/071 165 A1, in turn, describes a device and a method for repairing turbine blades of gas turbines by means of powder deposition welding, where a radiation source, such as a laser or an electron beam, is used for deposition welding. At the same time, an induction coil is provided as a heating device for heating the blade to be repaired.

Moreover, International Patent Application WO 2012/048 696 A2 discloses a method for additive manufacturing of components, where, in addition to the high-energy beam used for melting the powder, a second high-energy beam is used to perform a subsequent heat treatment on the solidified material. In addition, the component is also globally heated to a specific minimum temperature.

### SUMMARY OF THE INVENTION

Thus, in additive manufacturing methods where powder particles are melted or sintered by irradiation to form a component, it is known in the art to additionally provide for heating of the component. Nevertheless, there are still problems in using such additive manufacturing methods for high-temperature alloys which are not meltable or weldable, because frequently unacceptable cracking occurs in such alloys.

It is an object of the present invention to provide a method and apparatus for additive manufacturing of components that will effectively prevent the formation of cracks during manufacture. At the same time, the apparatus should be simple in design, and the method should be easy to carry out.

The present invention provides that the heating of the solidified or solidifying component, whether it be by local or global heating of the component, and the relaxation of the component's material under the action of temperature, as described in the prior art, may sometimes not be sufficient to prevent cracking, so that, as an additional countermeasure for preventing cracks, compressive stresses are induced in the component so as to effectively prevent cracking. To this end, the temperature distribution in the solidification region can be temporally and/or locally adjusted in such a way that residual compressive stresses will be present in the solidifying material or in the solidified component. The “solidification region” is understood to be the region of the component which has just been left by the high-energy beam, such as, for example, a laser used for melting the powder. Accordingly, the solidification region may also contain molten material. Furthermore, the solidification region extends temporally and/or locally to the point where the solidified material has fallen below a certain temperature range, for example, below half the melting point of the powder material used or below one-third of the melting point of the material, which ensures that no significant structural changes can occur anymore in the solidified region that temporally and/or locally follows the solidification region.

Residual compressive stresses can be induced in the component to be produced by performing a heat treatment in the solidification region, including heating and/or cooling of the solidifying powder material. Since the heating is performed subsequent to the melting, it is also referred to as “post-heating”. Accordingly, the region in which post-heating takes place is referred to as “post-heating region.” Similarly, the region in which the solid powder material is cooled is referred to as “cooling region.” Since the solidification region moves along with the melting region across the surface of the component to be produced, the post-heating region and/or the cooling region are also moved across the component, so that in the sequence of manufacture of the component, the respective regions are located at different positions of the component. At the same time, each of the so-produced regions of the component goes through the phase of melting and solidification, with a phase of post-heating and/or cooling being gone through during solidification. Preferably, a combined treatment may be performed, including cooling after the melting and heating after the cooling, so that the cooling region is temporally and/or locally between the melting region and the post-heating region.

The post-heating region and/or the cooling region may extend beyond the path of the high-energy beam, so that regions which have not immediately previously been melted are also subjected to the respective heat treatment and/or cooling treatment.

In particular, the post-heating region and/or the cooling region may be provided concentrically around the melting region, and the cooling region, in particular, may be only partially annular.

The post-heating region may be configured as an annular heating region surrounding the melting region, in particular concentrically, so that the annular heating region enables both pre-heating of the not-yet-melted powder and post-heating of the solidifying material.

The component and/or the powder material may in addition be pre-heated or pre-cooled, either locally or globally; i.e., over the entire powder layer and/or the entire component.

The pre-heating temperature to which the component or the powder material may be brought may be selected to be in the range of from 40% to 90%, 50% to 90%, in particular 60% to 70%, of the melting point of the respective material.

The cooling temperature to which the component or the solidification region may be brought may be selected to be in the range of from 30% to 60%, preferably to be about 50% or less, of the melting point of the material used.

Accordingly, a suitable apparatus for carrying out the method includes at least one cooling device capable of cooling at least one region near the melting region. The cooling device may include a heat sink having a cooling medium, such as water or the like, flowing therethrough, or a Peltier element, or a spray device for a cooling medium, such as, for example, a cooling gas. The cooling device may be configured to be movable or such that the cooling can take place at different locations, so that the cooling region, just as a post-heating region or a pre-heating region, can be moved relative to the powder layer in fixed relationship with the high-energy beam.

### BRIEF DESCRIPTION OF THE DRAWINGS

The enclosed drawings show purely schematically in

FIG. 1: a schematic view of an apparatus for additive manufacturing of components, which is, based, by way of example, on selective laser melting;

FIG. 2: a plan view of an apparatus according to the present invention for concurrently manufacturing a total of three components and having two movable induction coils;

FIG. 3: a detail view of the processing region of FIG. 2;

FIG. 4: a view illustrating another configuration of the temperature zones around the point of incidence of the laser beam; i.e., around a melting region; and in

FIG. 5 a view illustrating yet another configuration of the temperature zones around the point of incidence of the laser beam; i.e., around a melting region.

### DETAILED DESCRIPTION

Other advantages, characteristics and features of the present invention will become apparent from the following detailed description of an exemplary embodiment. However, the present invention is not limited to this exemplary embodiment. All functionally or structurally related components or parts of the invention may be utilized separately or in any combination within the scope of the present invention, even if they are not described individually herein.

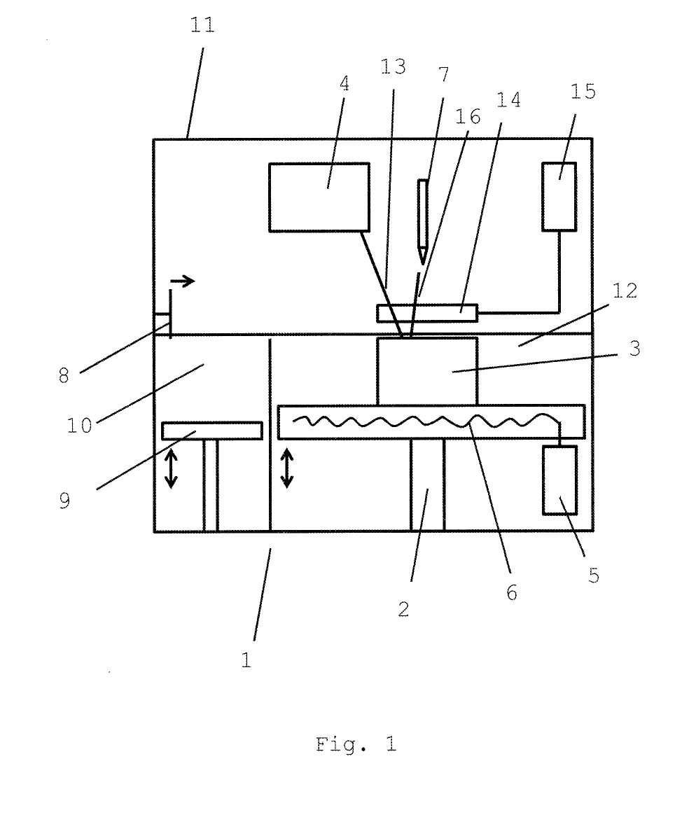

FIG. 1 shows, purely schematically, an apparatus 1, such as may be used, for example, for selective laser melting for additively manufacturing a component. Apparatus 1 includes a lifting table 2, on the platform of which is positioned a semi-finished product 3 on which material is deposited in layers to produce a three-dimensional component. To this end, powder 10 located in a powder reservoir above a lifting table 9 is pushed by a wiper 8 onto semi-finished product 3 layer by layer and subsequently bonded by melting to the existing semi-finished product 3 by means of the laser beam 13 of a laser 4. Laser 4 bonds the powder material in a powder layer to semi-finished product 3 according to the desired contour of the component to be produced, which makes it possible to produce any desired three-dimensional shape. Accordingly, laser beam 13 is scanned across powder bed 12 to melt powder material at different points of incidence on the powder bed according to the contour of the three-dimensional component in a cross-sectional plane that corresponds to the layer plane produced, and to bond the powder material to the already produced part of a component or to an initially provided substrate. For this purpose, laser beam 13 may be scanned across the surface of powder bed 12 by a suitable deflection unit and/or the powder bed could be moved relative to laser beam 13.

In order to prevent unwanted reactions with the surrounding atmosphere during melting or sintering, the process may take place in a sealed chamber provided by a housing 11 of apparatus 1 and, in addition, an inert gas atmosphere may be provided, for example, to prevent oxidation of the powder material or the like during deposition. The inert gas used may, for example, be nitrogen which is provided via a gas supply (not shown).

It would also be possible to use a different process gas in place of the inert gas, for example, when reactive deposition of the powder material is desired.

Furthermore, other types of radiation are also possible, such as, for example, electron beams or other particle beams or light beams, which are used in stereolithography and capable of melting the powder.

In order to obtain the desired temperatures in the component 3 produced and/or in powder bed 12, an electric resistance heater including a resistance heater controller 5 and an electric heater wire 6 is provided in the lifting table, making it possible to bring powder bed 12 and component 3 to a desired temperature by heating from below and/or to obtain a desired temperature gradient, in particular toward the layer being processed at the surface of the powder bed. Similarly, provision is made for heating from the top of powder bed 12 and the already produced component 3 by means of a heater which, in the exemplary embodiment shown, takes the form of an induction heater including an induction coil 14 and an induction heater controller 15. Induction coil 14 surrounds laser beam 13, and when necessary, can be moved parallel to the surface of powder bed 12 in a manner corresponding to laser beam 13.

Instead of the induction heater shown, any other type of heater capable of heating powder bed 12 and the already produced component 3 from the top may be used, such as, for example, radiation-type heaters, such as infrared heaters and the like. It would also be possible to provide heating by means of a second high-energy beam, such as a laser beam or an electron beam, that follows the first high-energy beam 13, which is used for melting the powder.

Similarly, resistance heater 5, 6 may be replaced by other suitable types of heaters capable of heating powder bed 12 and the already produced component 3 from below. In addition, it is possible to provide further heating devices surrounding the already produced component 3 and/or powder bed 12 to enable powder bed 12 and/or the already produced component 3 to be heated from the side.

In addition to heating devices, it is also possible to provide cooling devices or combined heating/cooling devices which, additionally or alternatively to heating the already produced component 3 and powder bed 12, allow also for selective cooling to thereby adjust the temperature balance in powder bed 12 and/or in the already produced component 3, and especially to adjust the temperature gradients produced, making it possible to induce the desired residual compressive stresses. In particular with respect to powder material melted by laser beam 3 in the melting region and the solidification front surrounding the melting region, it is possible to adjust the temperature distribution in order to induce residual compressive stresses.

The cooling devices may be provided in a manner enabling the solidifying or solidified material between the melting region and the region of post-heating to be selectively cooled by, for example, inductive heating. For example, in the apparatus of FIG. 1, a nozzle 7 is provided which allows a cooling medium, such as, for example, a cooling gas, to be blown onto the solidifying or solidified material. This allows suitable residual compressive stresses to be induced in the built-up layer, the residual compressive stresses serving to prevent cracking

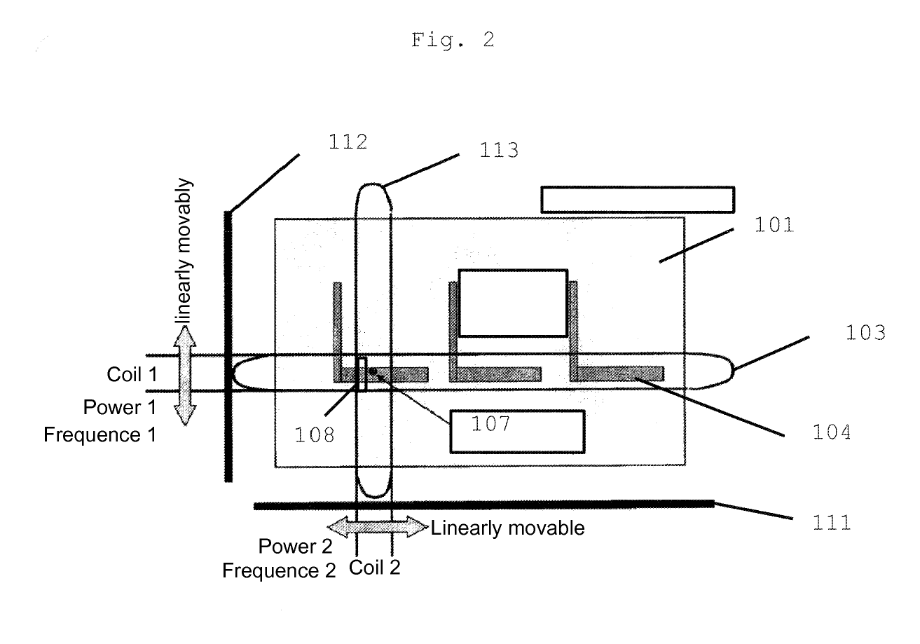

FIG. 2 is a plan view of another embodiment of an inventive apparatus 100, which is at least partially identical to the embodiment of FIG. 1, or in which at least some parts may be of identical design. In the embodiment of FIG. 2, for example, three components 104 can be manufactured concurrently in a processing chamber. The respective powder bed chambers are not explicitly shown in FIG. 2.

The apparatus of FIG. 2 includes two coils 103, 113 capable of being moved linearly along rail devices 111, 112. Coils 103, 113 extend along the entire width and length, respectively, of the processing chamber and can therefore cover all areas for the manufacture of components 104. Alternatively, it is also conceivable to make coils 103, 113 smaller, so that they cover only a partial area of the processing chamber. In this case, in addition, linear movability perpendicular to the respective rail devices 111, 112 may be provided instead to be able to position coils 103, 113 at any position of the processing chamber.

In FIG. 2, laser beam 107, which is directed from above onto the components 4 to be produced, schematically indicates how the laser beam can be moved over the processing chamber to produce components 104. In order to prevent laser beam 107 from being blocked, coils 103, 113 may also be moved according to the movement of laser beam 107 and, in particular, be briefly moved out of the range of operation of laser beam 107.

Coils 103, 113 are movable along rails 111, 112 in one plane or rather in two spaced-apart planes which are oriented substantially parallel to the surface in which the powder is melted by laser beam 107. Laser beam 107 may be provided, in particular, in the region of intersection of coils 103, 113, so that, on the one hand, the not-yet-melted powder can be pre-heated by induction coils 103, 113 and, on the other hand, the melt that has already solidified to form the component can be subjected to a thermal post-treatment. Due to the movability of induction coils 103, 113 and the corresponding movability and orientation of laser beam 107, all areas of the processing chamber containing the powder bed chambers can be reached, so that arbitrary components 104 can be produced and treated accordingly.

In addition, in the exemplary embodiment shown in FIG. 2, a Peltier element 108 is provided in the region of intersection of coils 103, 113. Peltier element 108 creates a cooling region between laser beam 107 and the melting region produced by it and the post-heating region, allowing intermediate cooling of the melt or the solidifying material around the solidification front and/or of the already solidified material, which in turn makes it possible to produce residual compressive stresses which counteract the formation of cracks.

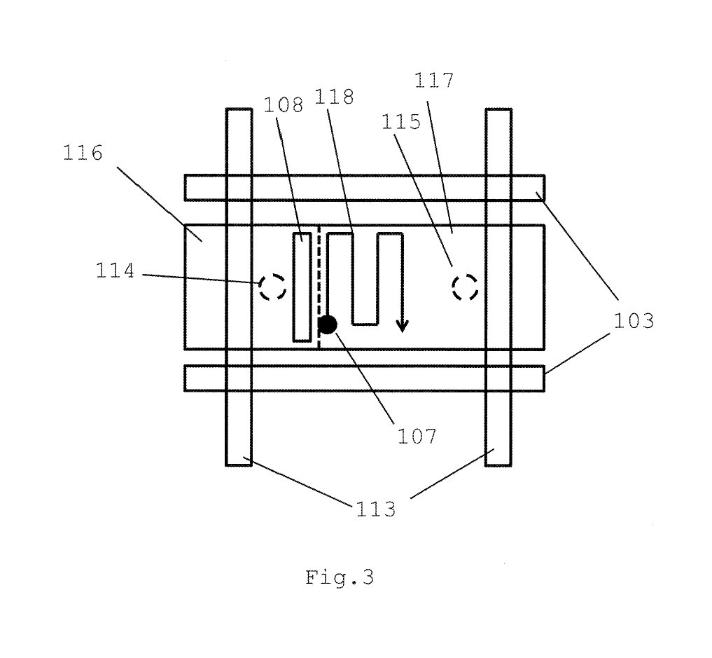

FIG. 3 shows a portion of FIG. 2 in greater detail, illustrating in particular the region of intersection of induction coils 103, 113.

Laser beam 107 is incident within the region of intersection and is moved across the powder bed along a meander-shaped laser path 118 to melt the powder. Once laser beam 107 has moved further along laser path 118, the melt solidifies to form the component to be produced. In FIG. 3, solidified region 116 is shown in the left portion of the figure. Accordingly, the loose powder disposed on the already produced component 104 located therebelow is shown in the right portion of FIG. 3 and is there denoted by reference numeral 117 for the powder region. The division between powder region 117 and solidified region 116 is schematically indicated by a dashed line and corresponds roughly to the solidification front.

Induction coils 103, 113 each have a temperature measurement point 114, 115 associated therewith. First temperature measurement point 114 is located in the region 116 of solidified melt, while second temperature measurement point 115 is provided in powder region 117, so that the temperature conditions can be measured ahead of and behind the melting region produced by laser beam 107.

Also disposed in the region of intersection of induction coils 103, 113 is a Peltier element 108 which allows intermediate cooling of the solidifying material between the post-heating region created by induction coils 103, 113. This intermediate cooling is to be considered both locally and temporally because the cooling by Peltier element 108 is (locally) between the melting region produced by laser beam 107 and the post-heating region produced by induction coils 103, 113, and because in the temporal sequence, a powder to be bonded to the component is initially present as a powder material, is then in the melted state, and subsequently cooled and then heated once again.

In the exemplary embodiment shown, Peltier element 108, just as induction coils 103, 113 moves along with laser beam 107 in accordance with a coarse or primary movement of laser beam 107, while the subtleties of, for example, an oscillating movement of the laser beam are not reproduced by the movement of induction coils 103, 113 and/or Peltier element 108.

With the movement of laser beam 107 along laser path 118 across the working surface, induction coils 103, 113 and/or Peltier element 108 may also be moved to substantially maintain their positional relationship with respect to laser beam 107. However, it is not necessary to convert every movement of laser beam 107 into a corresponding movement of induction coils 103, 113 and/or of the Peltier element. Rather, it is sufficient if, for example, laser beam 107 remains within the region of intersection of induction coils 103, 113 and if Peltier element 108 assumes a fixed position with respect to induction coils 103, 113. In the exemplary embodiment shown, this means that laser beam 107 does indeed move oscillatingly up and down in FIG. 3 along laser path 118, but does not leave the region of intersection of induction coils 103, 113 during this movement. Therefore, induction coil 103 can be held stationary. However, laser beam 107 moves from left to right in FIG. 3 along laser path 118, so that induction coil 113 and the Peltier element are also moved to the right with increasing movement of laser beam 107 to the right. Temperature measurement points 114, 115 will also perform a movement to the right according to the movement of induction coil 113, while in a direction perpendicular thereto; i.e., upward or downward in FIG. 3, temperature measurement points 114, 115 and Peltier element 108 will remain stationary with respect to induction coil 103. Accordingly, in the embodiment shown, Peltier element 108 and the two temperature measurement points 114, 115 are each fixed in one direction with respect to each of coils 103, 113. In the direction extending from left to right or vice versa in FIG. 3, temperature measurement points 114, 115 and Peltier element 108 are fixed with respect to induction coil 113, while in a direction perpendicular thereto; i.e., in a direction from top to bottom or vice versa in FIG. 3, Peltier element 108 and temperature measurement points 114, 115 are fixed with respect to induction coil 103. This makes it possible to obtain constant temperature conditions as the solidification front advances, so that constant melting conditions with defined local temperature gradients can be obtained along with high production speeds, while at the same time making it possible to prevent the formation of cracks and the like during solidification.

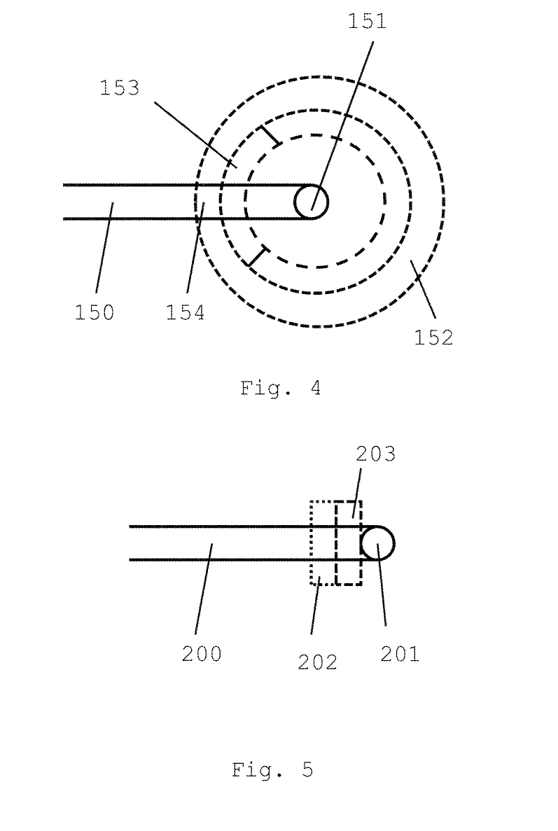

FIGS. 4 and 5 illustrate further ways of how to incorporate suitable residual compressive stresses in the component in order to prevent or reduce cracking In the embodiment of FIG. 4, again, a laser beam produces a melting region 151 which moves across the powder surface along the path of movement 150 of the laser beam. A heating region 152 is created concentrically around melting region 151; i.e., the region of incidence of the laser beam, by means of, for example, an induction ring or other annular heating device, or a heating device capable of producing an annular heating region Annular heating region 152 may be used both to pre-heat the powder material prior to impingement of the laser beam and to post-heat the solidifying or solidified powder material in the path of movement 150, and more specifically, in the area of intersection of annular heating region 152 and the path of movement 150 of the laser beam.

In addition, a partially annular cooling region 153 is provided concentrically with melting region 151 and annular heating region 152, the annular cooling region being disposed between melting region 151 and the following heating region 152 in order to induce residual compressive stresses in the built-up component by intermediate cooling.

FIG. 5 shows other configurations of a heating region 202 following the laser beam and a cooling region 203. Again, a melting region 201 can be seen which is produced, for example, by a laser beam along its path of movement 200, the melting region being immediately followed by an approximately rectangular cooling region 203 extending transversely across the path of movement 200, so that not only the material that has immediately previously been located in melting region 201 is cooled, but also the corresponding peripheral regions. Cooling region 203 is followed by a heating zone 202, which is also approximately rectangular and is provided locally and temporally subsequent to cooling region 203 to reheat the material adjacent to cooling region 203; i.e., the previously cooled material, so as to also produce residual compressive stresses in the component produced to counteract the formation of cracks.

Although the present invention has been described in detail with reference to the exemplary embodiment thereof, those skilled in the art will understand that it is not intended to be limited thereto and that modifications or additions may be made by omitting individual features or by combining features in different ways, without departing from the protective scope of the appended claims. The present invention includes, in particular, any combination of any of the individual features presented herein.

What is claimed is:

1. A method for additive manufacturing of components, comprising:
building up the component is at least partially layer by layer on a substrate or a previously produced part of the component, the layer-by-layer build-up being performed by layerwise melting of powder material using a high-energy beam and solidification of the molten powder, the high-energy beam moving along a path across the powder material and producing a melting region at the front of the path, and a solidification region forming subsequently in the path,
wherein in the solidification region, the temperature distribution is temporally or locally selected in such a way that residual compressive stresses are produced in the solidified or solidifying powder material.

2. The method as recited in claim 1 wherein in the solidification region, the solidifying powder material is post-heated or cooled, the post-heating being performed in at least one post-heating region or the cooling being performed in at least one cooling region.

3. The method as recited in claim 2 wherein the post-heating region or the cooling region extends beyond the path of the high-energy beam.

4. The method as recited in claim 3 wherein the post-heating region or the cooling region extends concentrically around the melting region.

5. The method as recited in claim 1 wherein an annular heating region is provided around the melting region, the annular heating region surrounding the melting region.

6. The method as recited in claim 5 wherein the annular heating region surrounds the melting region concentrically.

7. The method as recited in claim 1 wherein the post-heating region or the cooling region or the heating region move across the powder material in fixed positional relationship with the high-energy beam.

8. The method as recited in claim 1 wherein the component or the powder material are pre-heated or pre-cooled.

9. The method as recited in claim 8 wherein the component or the powder material are pre-heated or pre-cooled locally shortly before reaching the high-energy beam or globally over the entire powder layer or the entire component.

10. The method as recited in claim 8 wherein the component or the powder material is preheated and the pre-heating temperature is selected to be in the range of from 50% to 90% of the melting point.

11. The method as recited in claim 8 wherein pre-heating temperature is selected to be in the range of from 60% to 70% of the melting point.

12. The method as recited in claim 2 wherein the cooling temperature is selected to be in the range of from 30% to 60% of the melting point of the melting point of the material used, or is in the range of 600-700° C.

13. The method as recited in claim 2 wherein the cooling temperature is selected to be about 50% or less of the melting point of the material used.

14. An apparatus for additive manufacturing of components by layer-by-layer deposition of powder material on a substrate or a previously produced part of the component, the apparatus comprising:
a powder laying device capable of laying on the substrate a layer of powder to be deposited as a layer;
a beam generation device for generating a high-energy beam melting the laid-down powder in a melting region;
a moving device for creating relative movement between the high-energy beam and the powder layer; and
at least one cooling device capable of cooling at least one region near the melting region.

15. The apparatus as recited in claim 14 wherein the cooling device includes a heat sink having a cooling medium flowing therethrough, or a Peltier element, or a spray device for a cooling medium.

16. The apparatus as recited in claim 14 wherein the cooling device is movable across the powder layer along with the high-energy beam.

17. An apparatus for performing the additive manufacturing as recited in claim 1, the apparatus comprising:
a powder laying device capable of laying on the substrate a layer of powder to be deposited as a layer;
a beam generation device for generating a high-energy beam melting the laid-down powder in a melting region;
a moving device for creating relative movement between the high-energy beam and the powder layer; and
at least one cooling device capable of cooling at least one region near the melting region.

18. The method as recited in claim 1 wherein the components are turbomachine components.
